(19) United States
(12) Patent Application Publication
(10) Pub. No.: US 2005/0234693 A1
(43) Pub. Date: Oct. 20, 2005

(54) Computer-readable recording medium recorded with simulation program for causing computer to simulate liquid crystal molecule arrangement in liquid crystal element and program of the same

(75) Inventor: Takashi Sasabayashi, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/940,305

(22) Filed: Sep. 14, 2004

(30) Foreign Application Priority Data
Apr. 14, 2004 (JP) 2004-119274

(51) Int. Cl. G06F 17/50

(52) U.S. Cl. 703/13

(57) ABSTRACT

In a computer-readable recording medium recorded with a simulation program for causing a computer to simulate a liquid crystal molecule arrangement in a liquid crystal element, the simulation program includes the steps of setting a dispersion range of at least one factor which determines the liquid crystal molecule arrangement and determines an orientation direction of each of liquid crystal molecules in the liquid crystal element within the dispersion range set in said setting the dispersion range.

### BACKGROUND OF THE INVENTION

1. Field of the Invention

The present invention generally relates to computer-readable recording media recorded with a simulation program for causing a computer to simulate a liquid crystal molecule arrangement in a liquid crystal element and programs of the same, and more particularly to a computer-readable recording medium recorded with a simulation program for causing a computer to simulate the orientation of the liquid crystal element in a liquid crystal element with a measure of dispersion of the orientation and a program of the same.

2. Description of the Related Art

Conventionally, simulation software for simulating an orientation of a liquid crystal element has been widely used to calculate what type of an optical characteristic can be obtained as a result from arranging a liquid crystal molecule when a property of a dielectric constant of the liquid crystal or a like, an arrangement of an electrode or a like, and an applied voltage are changed. Thus, the simulation software has been widely used to develop the liquid crystal element.

However, in an actual liquid crystal element, orientation directions and anchoring energies of the liquid crystal molecule, properties of components of the liquid crystal, and the like cannot be simulated perfectly. For example, in a liquid crystal element applying a vertically aligned film, a liquid crystal molecule is vertically oriented with respect to a substrate interface. In this case, the liquid crystal molecule is not perfectly vertically oriented with respect to a substrate surface but the liquid crystal molecule is evenly vertically oriented with a measure of dispersion because of a delicate irregularity of the substrate surface and a state of an orientation film surface.

In conventional simulation software, for example, since an azimuthal angle and/or a polar angle and an elastic constant K₁₁ of the liquid crystal molecule are fixed to be 45°, 89°, and 8.0 pN, respectively, the dispersion of the liquid crystal element is not considered. As a result, an actual phenomenon cannot be reproduced. The following IDS or Cross-References are to Related Applications:
Japanese Laid-open Patent Application No. 2002-296557
Japanese Laid-open Patent Application No. 8-29747
Japanese Laid-open Patent Application No. 11-24023
Japanese Laid-open Patent Application No. 11-306231
Japanese Laid-open Patent Application No. 9-113910
Japanese Laid-open Patent Application No. 2-251888.

### SUMMARY OF THE INVENTION

It is a general object of the present invention to provide computer-readable recording media recorded with a simulation program for causing a computer to simulate a liquid crystal molecule arrangement in a liquid crystal element and programs of the same, in which the above-mentioned problems are eliminated.

A more specific object of the present invention is to provide a computer-readable recording medium recorded with a simulation program for causing a computer to simulate the liquid crystal molecule arrangement in a liquid crystal element with a measure of dispersion of the orientation and a program of the same, so that a phenomenon in an actual liquid crystal element can be faithfully reproduced.

The above objects of the present invention are achieved by a computer-readable recording medium recorded with a simulation program for causing a computer to simulate a liquid crystal molecule arrangement in a liquid crystal element, said simulation program including the steps of setting a dispersion range of at least one factor which determines the liquid crystal molecule arrangement; and determining an orientation direction of each of liquid crystal molecules in the liquid crystal element within the dispersion range set in said setting the dispersion range.

According to the above invention, in a computer installing the simulation program stored in the computer-readable recording medium, it is possible to truly reproduce a phenomenon in an actual liquid crystal element since the orientation direction of the liquid crystal element is simulated considering dispersion of the orientation direction.

The above objects of the present invention can be achieved by a simulation program for causing a computer to simulate a liquid crystal molecule arrangement in a liquid crystal element, by a simulation apparatus for simulating a liquid crystal molecule arrangement in a liquid crystal element, or by a simulation method for simulating a liquid crystal molecule arrangement in a liquid crystal element.

### BRIEF DESCRIPTION OF THE DRAWINGS

Other objects, features and advantages of the present invention will become more apparent from the following detailed description when read in conjunction with the accompanying drawings, in which:

FIG. 1 is a diagram illustrating a configuration of a liquid crystal element;

FIG. 2 is a diagram showing the hardware configuration of the simulation apparatus according to the embodiment of the present invention;

FIG. 3 is a flowchart for explaining a process for calculating the orientations of the liquid crystal molecules with a course of time, according to the embodiment of the present invention;

FIG. 4 is a diagram showing an orientation state of the liquid crystal molecule on an interface;

FIG. 5 is a diagram showing the orientation state of the liquid crystal molecule;

FIG. 6 is a diagram for explaining a node point;

FIG. 7 is a diagram for explaining the setting process of the initial orientation;

FIG. 8A is a diagram showing an example of an orientation setting dialog of the liquid crystal molecule, and FIG. 8B is a diagram illustrating the orientation setting dialog for setting the orientation of the liquid crystal molecule when the dispersion range a is checked;

FIG. 9 is a diagram illustrating a detail setting screen;

FIG. 10 is a diagram showing an area displayed by a simulation program according to the embodiment of the present invention;

FIG. 11A is a diagram showing a first calculation result at each time change, which is conducted by the simulation program according to the embodiment of the present invention and FIG. 11B is a diagram showing a second calculation result at each time change, which is conducted by the simulation program according to the embodiment of the present invention; and

FIG. 12A and FIG. 12B are diagrams showing an orientation state of the liquid crystal molecules 6 at the same time t(k) in FIG. 11A and FIG. 11B.

### DESCRIPTION OF THE PREFERRED EMBODIMENT

An embodiment according to the present invention will be described with reference to the accompanying drawings.

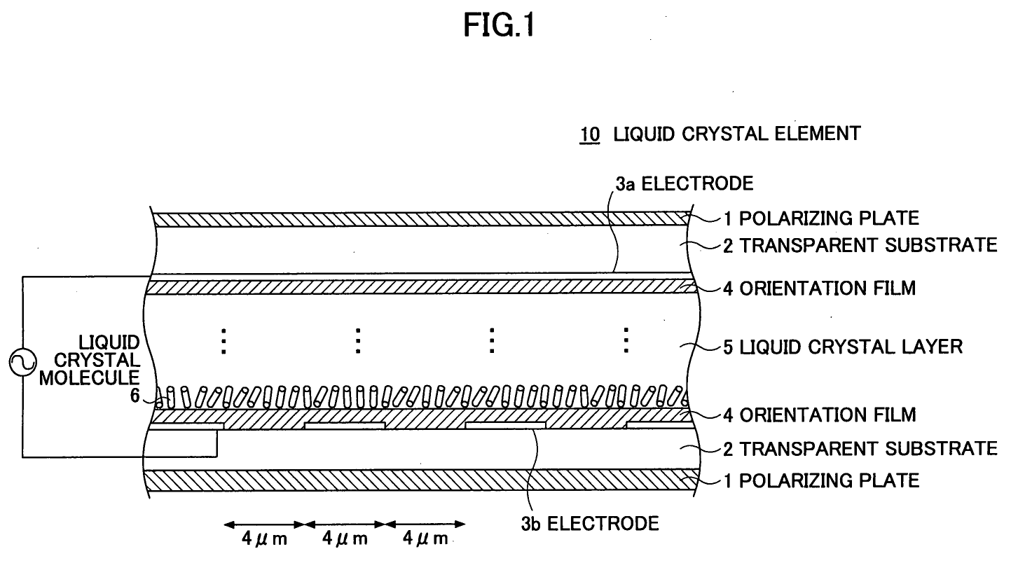

FIG. 1 is a diagram illustrating a configuration of a liquid crystal element. In FIG. 1, a liquid crystal element 10 includes a pair of transparent substrates 2, electrodes (or dielectric constant layers) 3a and 3b formed on (inside) the transparent substrates 2, orientation films 4 formed so as to cover the electrodes 3a and 3b, a liquid crystal layer 5 being filled with a liquid crystal between the transparent substrates 2, and polarizing plates 1 formed by a polarizing film or a phase difference film being arranged outside the transparent substrates 2.

For example, in the liquid crystal element 10, the electrode 3a is formed in front of an upper one of the transparent substrates 2, and the electrode 3b is formed to be striped on a bottom one of the transparent substrates 2. By changing voltage applied to the electrodes 3a and 3b, an arrangement of the liquid crystal molecules is changed. Accordingly, a display is conducted by changes of light transmitted or reflected from the liquid crystal element 10.

In the actual liquid crystal element 10, orientation directions and anchoring energy of the liquid crystal molecules 6 and properties of components of the liquid crystal cannot be perfectly even.

For example, in the liquid crystal element 10, when a vertically aligned film is applied, the liquid crystal molecules 6 are approximately vertically oriented with respect to the substrate interface in an off state in which a voltage is not applied. In this case, the liquid crystal molecules 6 are not perfectly and vertically oriented with respect to the substrate surface but are approximately vertically oriented with a measure of dispersion because of a delicate irregularity of a substrate surface and a sate of an orientation film surface.

In addition, similarly, in an on state in that the voltage is applied, the liquid crystal molecules 6 are oriented with respect to the substrate interface. In this case, all liquid crystal molecules 6 are uniformly tilted toward an identical direction with the same angle but each of the liquid crystal molecules 6 are oriented so as to tilt at an approximate similar angle with a measure of dispersion.

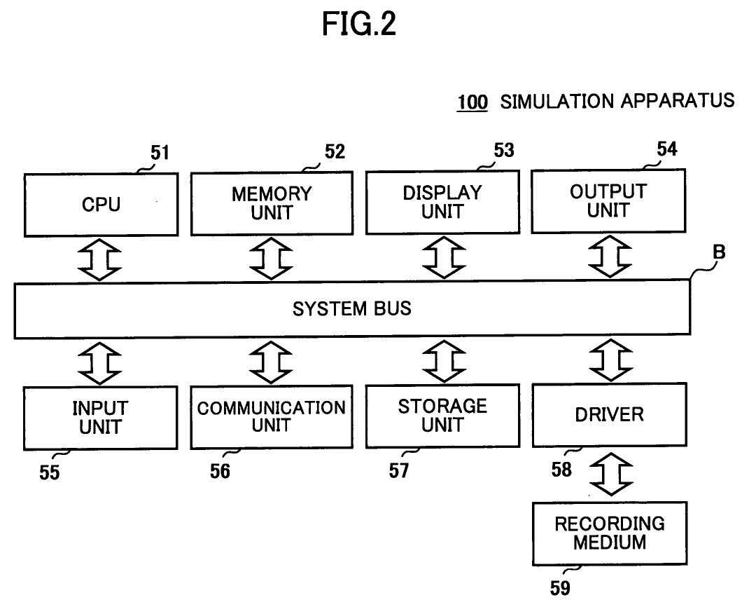

A simulation apparatus according to the embodiment of the present invention, which can reproduce a state in that the liquid crystal molecules 6 tilt at the approximate similar angle while dispersing, includes a hardware configuration as shown in FIG. 2. FIG. 2 is a diagram showing the hardware configuration of the simulation apparatus according to the embodiment of the present invention.

In FIG. 2, the simulation apparatus 100 is a terminal being controlled by a computer, and includes a CPU (Central Processing Unit) 51, a memory unit 52, a display unit 53, an output unit 54, an input unit 55, and a communication unit 56, a storage unit 57, and a driver 58, which are mutually connected to each other by a system bus B.

The CPU 51 controls the simulation apparatus 100 in accordance with programs stored in the memory unit 52. The memory unit 52 includes a RAM (Random Access Memory) and a ROM (Read-Only memory), and stores the programs to be executed by the CPU 51, data necessary to be processed by the CPU 51, data obtained in a process by the CPU 51, and the like. In addition, a part of an area of the memory unit 52 is assigned as a work area utilized in the process by the CPU 51.

The display unit 53 displays various information necessary under a control of the CPU 51. The output unit 54 includes a printer or a like, and is used to output various information in response to an instruction from a user. The input unit 55 includes a mouse, a keyboard, or a like, and is used by the user to input various information necessary for the simulation apparatus 100 to conduct the process. For example, the communication unit 56 is an unit to control a communication with other apparatuses in a case of connecting with other apparatuses through the Internet, a LAN (Local Area Network), or a like. For example, the storage unit 57 includes a hard disk unit, and stores data such as the program for conducting various processes.

For example, a simulation program for realizing a process conducted by the simulation apparatus 100 can be installed to the simulation apparatus 100 by a recording medium 59 such as a CD-ROM (Compact Disc Read-Only Memory). That is, when the recording medium 59 recording the simulation program is set to the driver 58, the driver 58 reads out the simulation program from the recording medium 59 and installs to the simulation program the storage unit 57 through the system bus B. Then, when the simulation program is activated, the CPU 51 starts the process in accordance with the simulation program being installed into the storage unit 57.

A recording medium storing the simulation program is not limited to the CD-ROM but can be any computer-readable recording medium. The simulation program according to the embodiment of the present invention may be downloaded through a network by the communication unit 56 and installed to the storage unit 57.

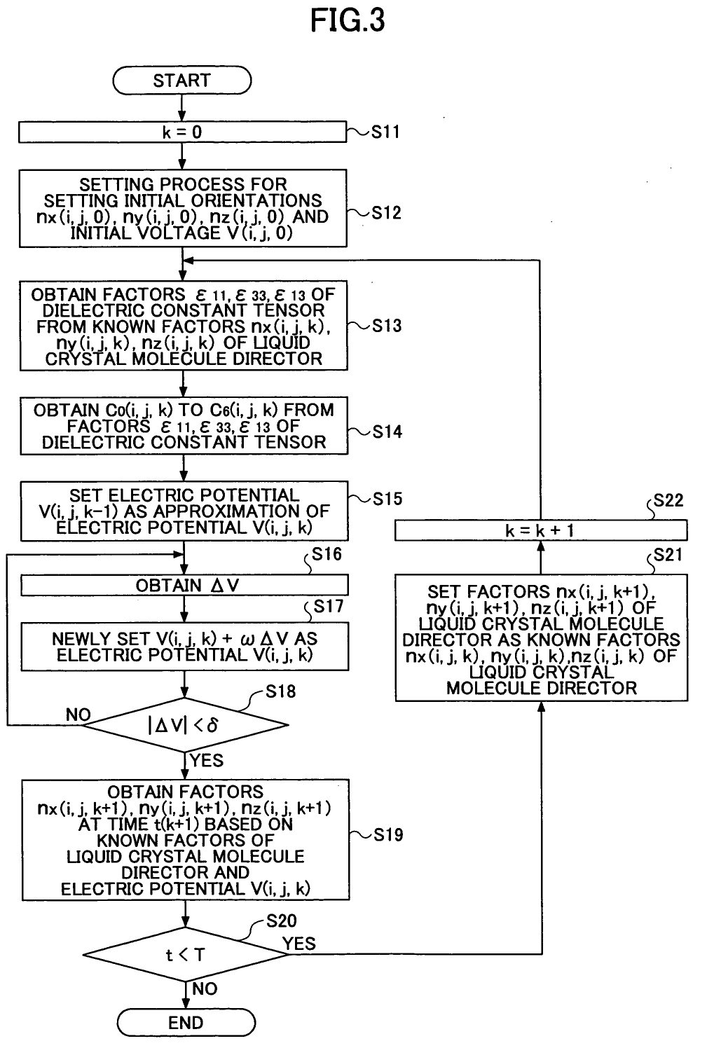

As described above, the simulation program according to the embodiment of the present invention, which can reproduce a state in that the liquid crystal molecules 6 are tilted at the similar angle while dispersing, conducts processes as described with reference to FIG. 3 through FIG. 9. FIG. 3 is a flowchart for explaining a process for calculating the orientations of the liquid crystal molecules 6 with a course of time, according to the embodiment of the present invention. The simulation program develops a simulation with the course of time while alternately calculating an electric potential and a liquid crystal molecule 6 director repeatedly.

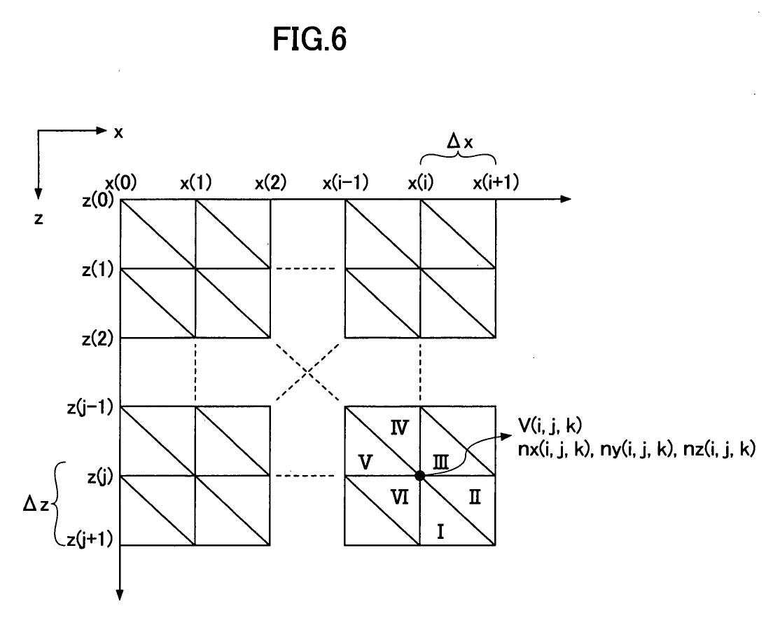

In FIG. 3, when the electric potential is calculated according to a finite element method, as shown in FIG. 6, a two-dimensional area is divided into elements being triangular. Apexes (hereinafter, called node points) of each of the elements are defined as (x(i),z(j)), and Äx=x(i+1)−x(i) and Äz=z(j+1)−z(j) are defined. In addition, a start calculation time is defined as t(0), and then, the electric potential is calculated at times t(1), t(2), . . . , t(k), . . . Also, Ät=t(k+1)−t(k) is defined. The electric potential at a time t(k) at the node point (x(i),z(j)) is defined as V(i,j,k). It is assumed that a factor of a dielectric constant tensor in each of the elements is constant. Hereinafter, for the sake of convenience, a case of the two-dimension will be described. However, a case of a one-dimension or a three-dimension can be applied in the same manner. Also, in each step, the same process is conducted for all node points (x(i),z(j)).

When the simulation program installed in the simulation apparatus 100 is activated, k=0 is set (step S11), the simulation program executes a setting process for initial orientation nₓ(i,j,0), n_{y}(i,j,0), and n_{z}(i,j,0) and an initial electric potential V(i,j,0) at a time t(0) (step S12).

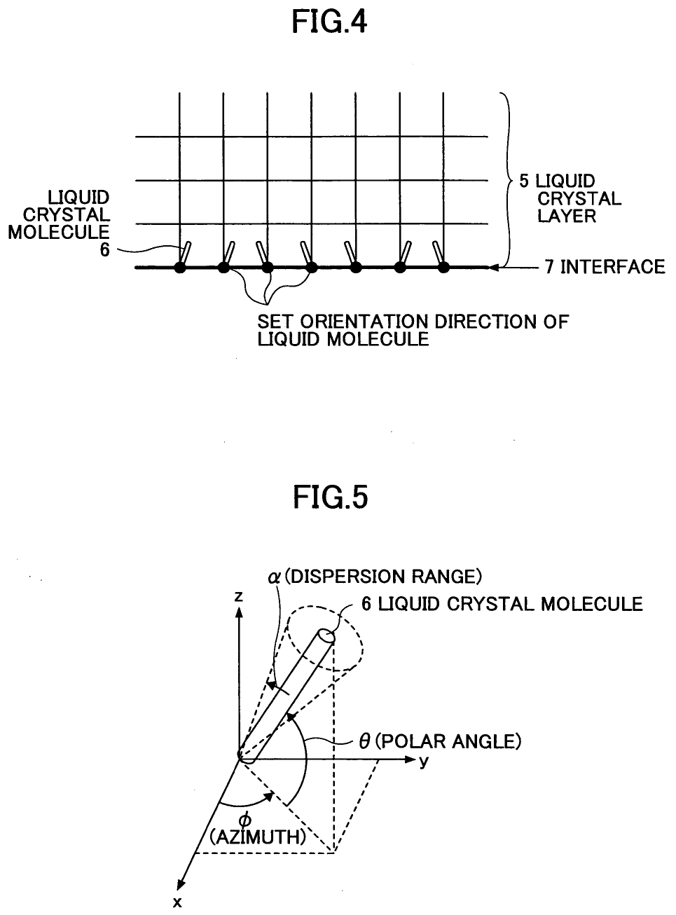

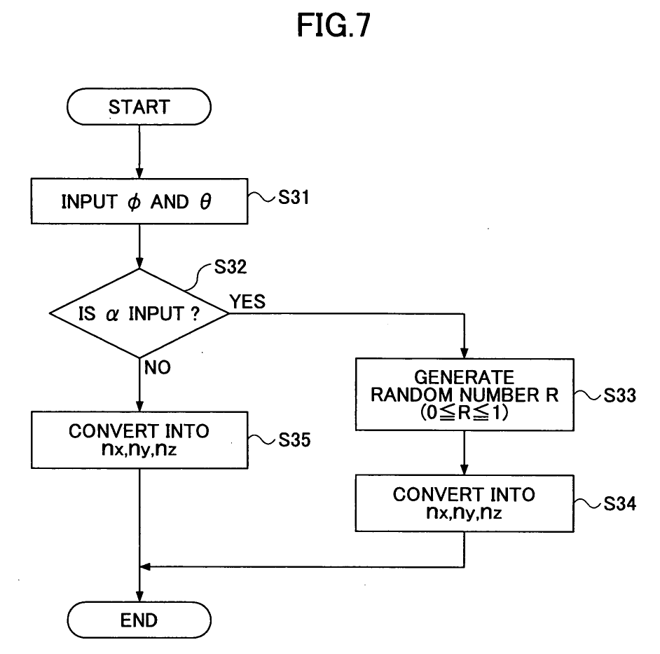

If necessary, the orientation direction of the liquid crystal molecules 6 and a dispersion range can be obtained from the user, and the orientation direction and the dispersion range are set to use for a calculation. That is, referring to FIG. 4 and FIG. 5, the user sets the orientation direction of the liquid crystal molecules 6 and also sets the dispersion range. By these settings, the simulation program randomly sets the orientation direction of each of the liquid crystal molecules 6 within a dispersion range α after the voltage is applied to the liquid crystal element 10. Accordingly, it is possible to simulate the orientation of each of the liquid crystal molecules 6 in the actual liquid crystal element 10. Details of a setting process for setting the initial orientation nₓ(i,j,0), n_{y}(i,j,0), n_{z}(i,j,0) will be described with reference to FIG. 7.

After the initial settings in step S12, factors ε₁₁, ε₃₃, and ε₁₃ of dielectric constant tensor are calculated by using known factors nₓ(i,j,0), n_{y}(i,j,0), n_{z}(i,j,0) of a liquid crystal molecule director (step S13). Moreover, based on the factors ε₁₁, ε₃₃, and ε₁₃ of the dielectric constant tensor, C₀(i,j,k), C₁(i,j,k), C₂(i,j,k) C₃(i,j,k), C₄(i,j,k), C₅(i,j,k), C₆(i,j,k) are calculated (step S14).

Referring to FIG. 6, the electric potential V within the element I approximates by a linear expression using coordinates x and y as follows:
V=α₁+α₂x+α₃z (1)

Since an electrical field E is shown by (−∂V/∂x,0, −∂V/∂z), the expression (1) is equal to an assumption in that each of the elements is sufficiently small so as to regard it “the electrical field is constant within each of the elements”. α₁, α₂, α₃ are given in the following expressions:
V(i,j,k)=α₁+α₂x(i)+α₃z(j) (2)
V(i,j+1,k)=α₁+α₂x(i)+α₃z(j+1) (3)
V(I+1,j+1,k)=α_{1+α}₂×(i+1)+α₃z(j+1) (4)

In general, as for a medium of the dielectric constant tensor ε, a next Laplace equation can be used.
div(εgrad)=0 (5)

The expression (5) is equal to minimizing the next functional X within the two-dimensional region.

$$\begin{matrix}X = 1 / 2 \int ( ɛ gradV ) * ( gradV ) ⅆ x ⅆ z \\ = 1 / 2 \int \{ {{ɛ}_{11} ( \partial V / \partial x )}^{2} + 2 {ɛ}_{13} ( \partial V / \partial x ) ( \partial V / \partial z ) + \\ {{ɛ}_{33} ( \partial V / \partial z )}^{2} \} ⅆ x ⅆ z\end{matrix} \qquad ( 6 )$$

ε₁₁, ε₃₃, and ε₁₃ are the factors of dielectric constant tensor. Since an area of each of the elements is ΔxΔz/2, Xₕ in each of the elements can be as follows:
Xₕ=(ΔxΔz/4) (ε₁₁ α₂²+2 ε₁₃α₂α₃+ε₃₃α₃²) (7)
α₂ and α₃ are calculated by the expressions (2), (3), and (4) and are substituted in the expression (7), so as to obtain a potential energy X_{I} of the element I. The potential energy X of the entire system is expressed as follows:
   X=ΣXₕ (all elements within the region) (8)

If V(i,j,k) is defined so as to minimize the potential energy X, a result of V(i,j,k) is an approximate value obtained under an assumption of the expression (1). Thus, it can be expected for the approximate value to approach a real electric potential if the elements are divided finely. In order to minimize the potential energy X, the electric potential V(i,j,k) at each node point is set as a variable parameter and a differential value with respect to each electric potential V(i,j,k) is set to be “0” (zero).

When the potential energy X is differentiated at the electric potential V(i,j,k) and is defined to be “0” (zero), as seen from FIG. 6, only six elements I through VI related to the node point (x(i),z(j)). That is,

$$\begin{matrix}\partial X / \partial V ( i , j , k ) = \partial {X}_{I} / \partial V ( i , j , k ) ) + \partial {X}_{II} / \partial V ( i , j , k ) + \\ \partial {X}_{III} / \partial V ( i , j , k ) + \partial {X}_{IV} / \partial V ( i , j , k ) + \\ \partial {X}_{V} / \partial V ( i , j , k ) + \partial {X}_{VI} / \partial V ( i , j , k ) \\ = 0\end{matrix} \qquad ( 9 )$$

The potential energy for each element is expressed by a quadratic expression regarding the electric potential V(i,j,k) at the node point (x(i),z(j)). Accordingly, when the potential energy is differentiated by the electric potential V(i,j,k), a linear expression regarding the electric potential V(i,j,k) (unknown value) is obtained. By defining the expression (9) for each of the electric potentials (i,j,k) at all node points (x(i),z(j)), the same number of simultaneous linear equations as the number of unknown values can be obtained. As a result, the expression (9) will be transformed as follows:

$${C}_{0} ( i , j , k ) V ( i , j , k ) = {C}_{1} ( i , j , k ) V ( i + 1 , j , k ) + {C}_{2} ( i , j , k ) V ( i - 1 , j , k ) + {C}_{3} ( i , j , k ) V ( i , j + 1 , k ) + {C}_{4} ( i , j , k ) V ( i , j - 1 , k ) + {C}_{5} ( i , j , k ) V ( i + 1 , j + 1 , k ) + {C}_{6} ( i , j , k ) V ( I - 1 , j - 1 , k ) \qquad ( 10 )$$

C₀(i,j,k), C (i,j,k), C₂ (i,j,k), C₃ (i,j,k) C₄(i,j,k), C₅(i,j,k), and C₆(i,j,k) are functions of the factors E 11, ±33, and E 13 of the dielectric constant tensor. The factors E 11, E 33, and E 130f the dielectric constant tensor are functions of the factors nₓ(i,j,k), n_{y}(i,j,k), and n_{z}(i,j,k) of the liquid crystal molecule director at the node point (x(i),z(j)).

Calculations according to the finite element method is described above but even a finite difference method is used, the same expression as the expression (10) can be obtained.

The simultaneous linear equations obtained by the expression (10) can be solved by an SOR (Successive Over-Relaxation) method.

Returning to the flowchart shown in FIG. 3, the simulation program sets the electric potential V(i,j,k−1) to be an approximate value of the electric potential V(i,j,k) (step S15). Then, ΔV is calculated (step S16). A value ΔV is calculated by subtracting the electric potential V(i,j,k-1) from the electric potential V(i,j,k). That is, the value ΔV is calculated by the following expression:

$$Δ V = \{ {C}_{1} ( i , j , k ) V ( i + 1 , j , k ) + {C}_{2} ( i , j , k ) V ( i - 1 , j , k ) + {C}_{3} ( i , j , k ) V ( i , j + 1 , k ) + {C}_{4} ( i , j , k ) V ( i , j - 1 , k ) + {C}_{5} ( i , j , k ) V ( i + 1 , j + 1 , k ) + {C}_{6} ( i , j , k ) V ( i - 1 , j - 1 , k ) \} / {C}_{0} ( i , j , k ) -- V ( i , j , k ) \qquad ( 11 )$$

Subsequently, the simulation program changes the electric potential V(i,j,k) by multiplying by an over-relaxation coefficient co and sets as a new electric potential V(i,j,k).

Accordingly, the simulation program multiplies ΔV by the over-relaxation coefficient ω, adds to the electric potential V(i,j,k), and newly set as the electric potential V(i,j,k) (step S17).
V(i,j,k)<-V(i,j,k)+ωΔV (12)

Next, the simulation program checks whether or not an absolute value of ΔV is smaller than a predetermined convergence condition 6 (step S18). If all electric potentials V(i,j,k) do not satisfy the predetermined convergence condition 6 the simulation program goes back to step S16 and repeats the same process described above. On the other hand, if ΔV is smaller than the predetermined convergence condition δ at all node points (x(i),z(j)), the electric potential V(i,j,k) being newly obtained is set as a solution.

The simulation program calculates the factors nₓ(i,j,k+1), n_{y}(i,j,k+1), and n_{z}(i,j,k+1) of the liquid crystal molecule director at a time t(k+1) by the factors nₓ(i,j,k), n_{y}(i,j,k), and n_{z}(i,j,k) of the known liquid crystal molecule director and the electric potential V(i,j,k) (step S19).

For example, according to a document (A. Kilian and S. Hess Z. Naturforsch. 44a, 693 (1989) and the like), a dynamic equation of the liquid crystal molecule director can be expressed as follows:
γ₁∂nᵤ/∂t=K_{com}{nₓΔ(nᵤnₓ)+n_{y}Δ(nᵤn_{y})+n_{z}Δ(nᵤn_{z})} (13)

In this expression, one elastic constant approximate (Frank's elastic constant K₁₁=K₂₂=K₃₃ K_{com}) is applied. γ₁ denotes a rotational velocity coefficient and λ denotes a Lagrange's undetermined multiplier. The expression (13) can be differenciated.

$${n}_{x} ( i , j , k + 1 ) = {n}_{x} ( i , j , k ) + {K}_{com} Δ t / {\tilde{a}}_{1} [ \{ {n}_{x} ( i + 1 , j , k ) ( {n}_{x} ( i , j , k ) {n}_{x} ( i + 1 , j , k ) + {n}_{y} ( i , j , k ) {n}_{y} ( i + 1 , j , k ) + {n}_{z} ( i , j , k ) {n}_{z} ( i + 1 , j , k ) ) - {n}_{x} ( i , j , k ) + {n}_{x} ( i - 1 , j , k ) ( {n}_{x} ( i , j , k ) {n}_{x} ( i - 1 , j , k ) + {n}_{y} ( i , j , k ) {n}_{y} ( i - 1 , j , k ) + {n}_{z} ( i , j , k ) {n}_{z} ( i - 1 , j , k ) ) - {n}_{x} ( i , j , k ) \} / Δ {x}^{2} + \{ {n}_{x} ( i , j + 1 , k ) ( {n}_{x} ( i , j , k ) {n}_{x} ( i , j + 1 , k ) + {n}_{y} ( i , j , k ) {n}_{y} ( i , j + 1 , k ) + {n}_{z} ( i , j , k ) {n}_{z} ( i , j + 1 , k ) ) - {n}_{x} ( i , j , k ) + {n}_{x} ( i , j - 1 , k ) ( {n}_{x} ( i , j , k ) {n}_{x} ( i , j - 1 , k ) + {n}_{y} ( i , j , k ) {n}_{y} ( i , j - 1 , k ) + {n}_{z} ( i , j , k ) {n}_{z} ( i , j - 1 , k ) ) - {n}_{x} ( i , j , k ) \} / Δ {z}^{2} ] + ΔɛΔ t / ( 4 {\tilde{a}}_{1} Δ x ) \{ V ( i + 1 , j , k ) - V ( i - 1 , j , k ) \} \cdot [ {n}_{x} ( i , j , k ) \{ V ( i + 1 , j , k ) - V ( i - 1 , j , k ) \} / Δ x + {n}_{z} ( i , j , k ) \{ V ( i , j + 1 , k ) - V ( i , j - 1 , k ) \} / Δ z ] \qquad ( 14 )$$

Since n_{y}(i,j,k+1) and n_{z}(i,j,k+1) can be expressed in the same manner, explanations thereof will be omitted. By the expression (14), unknown nₓ(i,j,k+1), n_{y}(i,j,k+1), and n_{z}(i,j,k+1) at a time t(k+1) are calculated from known nₓ(i,j,k), n_{y}(i,j,k), and n_{z}(i,j,k) at a time t(k). The Lagrange's Undetermined Multiplier λ normalizes nₓ(i,j,k+1), n_{y}(i,j,k+1), and n_{z}(i,j,k+1) obtained by the expression (14) as follows:
nₓ(i,j,k+1)<-nₓ(i,j,k+1)/((nₓ(i,j,k+1)²+n_{y}(i,j,k+1)²+n_{z}(i,j,k+1)²)^{1/2}
n_{y}(i,j,k+1)<-n_{y}(i,j,k+1)/((nₓ(i,j,k+1)²+n_{y}(i,j,k+1)²+n_{z}(i,j,k+1)²)^{1/2}
n_{z}(i,j,k+1)<-n_{z}(i,j,k+1)/((nₓ(i,j,k+1)²+n_{y}(i,j,k+1)²+n_{z}(i,j, k+1)²)^{1/2} (15)

As described above, nₓ(i,j,k+1) n_{y}(i,j,k+1), and n_{z}(i,j,k+1) are obtained.

The simulation program checks whether or not a predetermined time T lapses (t<T) (step S20). When the predetermined time T lapses, this process is terminated.

On the other hand, when the predetermined time T does not lapse, the simulation program sets the factors nₓ(i,j,k+1), n_{y}(i,j,k+1), and n_{z}(i,j,k+1) of the liquid crystal molecule director as the factors nₓ(i,j,k), n_{y}(i,j,k), and nₓ(i,j,k) of the liquid crystal molecule director (step S21), and increments k by one (step S22). The simulation program goes back to step S13 and repeats the above steps in the same manner, and terminates this process when the predetermined time T lapses.

Regarding the setting process for setting an initial orientation in step S12 in FIG. 3, a process, in which an azimuthal angle φ with respect to a x-axis of the liquid crystal molecule 6 as shown in FIG. 5, a polar angle θ with respect to a x-y plane, and a dispersion range α are set in response to inputs of a user, will be described with reference to FIG. 7. FIG. 7 is a diagram for explaining the setting process of the initial orientation.

As shown in FIG. 7, the simulation program obtains setting values by inputs of the azimuthal angle φ and the polar angle θ of the liquid crystal molecule 6 by the user (step S31).

Then, the simulation program checks whether or not the user inputs the dispersion range α (angle) of the liquid crystal molecule 6 (step S32). When the dispersion range α is input by the user, the simulation program generates a random number R in a range of 0≦R≦1 (step S33), and converts into the initial orientation nₓ(i,j,0) n_{y}(i,j,0), and n_{z}(i,j,0) (step S34). The simulation program executes a converting process regarding the node point (x(i),z(j)) where the orientation is defined. A converting formula for converting into the initial orientation nₓ(i,j,0), n_{y}(i,j,0), and n_{z}(i,j,0) concerning the dispersion range a is normalized as follows:
nₓ(i,j,0)=cos θcos φ−sin θ·cos φ·tan(αR)·sin(2πR)
n_{y}(i,j,0)=cos θsin φ−sin θ·sin φ·tan(αR)·sin(2πR)
n_{z}(i,j,0)=sin θ+cos θ·tan(αR) sin(2πR) (16)
furthermore,
nₓ(i,j,0)²+n_{z}(i,j,0)+n_{z}(i,j,0)²=1 (17)

After the simulation program converts into the initial orientation nₓ(i,j,0), n_{y}(i,j,0), and n_{z}(i,j,0), the simulation program terminates the setting process.

On the other hand, when the dispersion range α is not input by the user in step S32, the simulation program converts into the initial orientation nₓ(i,j,0), n_{y}(i,j,0), and n_{z}(i,j,0) where the dispersion range a is not considered (step S35). Then, the simulation program executes the converting process regarding the note point (x(i),z(j)) where the orientation should be set. A conversion formula for converting into the initial orientation nₓ(i,j,0), n_{y}(i,j,0), and n_{z}(i,j,0) can be expressed as follows:
nₓ(i,j,0)=cos θ cos φ
n_{y}(i,j,0)=cos θsin φ
n_{z}(i,j,0)=sin θ (18)

After the simulation program converts into the initial orientation nₓ(i,j,0), n_{y}(i,j,0), and n_{z}(i,j,0), the simulation program terminates the setting process.

By this converting process, an orientation direction of the liquid crystal molecule 6 can be randomly dispersed within an angle α centering a certain angle.

Moreover, other than the orientation direction of the liquid crystal molecule 6, it is possible to set an anchoring energy in a polar angle direction or an azimuthal angle direction at an interface for each node point so as to randomly disperse within a range of ΔE centering a value E, that is, within a range of E±ΔE.

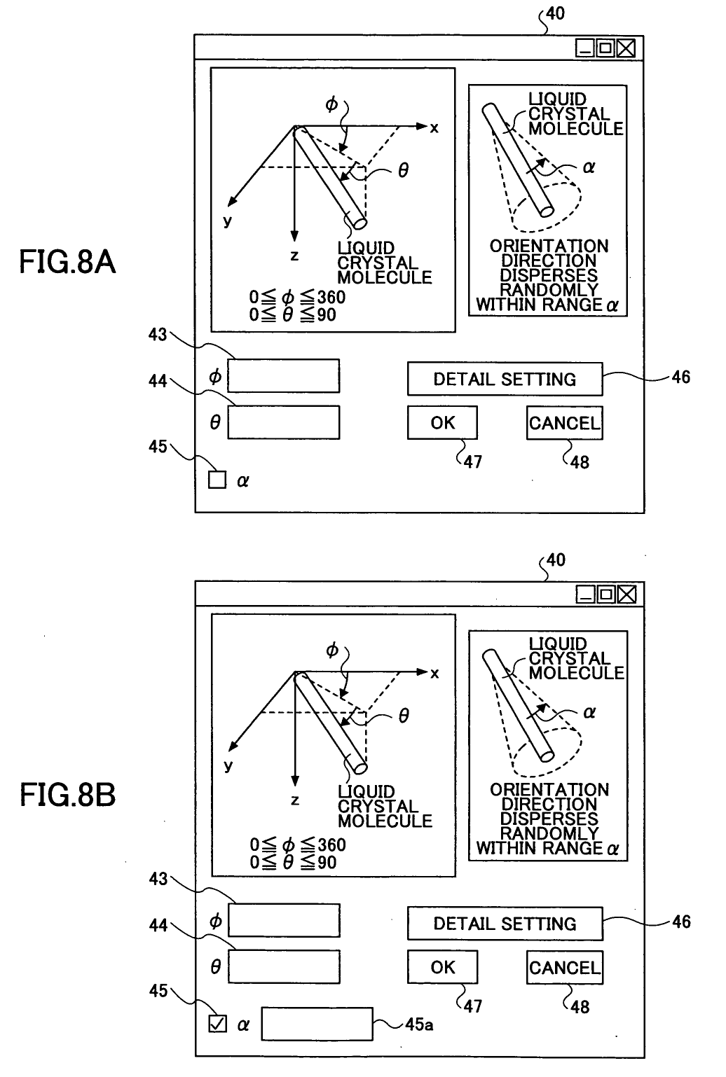

A screen example for the user to set the azimuthal angle φ, the polar angle θ, and the dispersion range α of the liquid crystal molecule 6 will be described with reference to FIG. 8A and FIG. 8B. FIG. 8A is a diagram showing an example of an orientation setting dialog of the liquid crystal molecule 6. In FIG. 8A, an orientation setting dialog 40 of the liquid crystal molecule 6 includes an input area 43 for inputting the azimuthal angle φ of the liquid crystal molecule 6, an input area 44 for inputting the polar angle θ of the liquid crystal molecule 6, a check area 45 for inputting the dispersion range α, a button 46 for setting a dispersion of each of detailed properties, an OK button 47 for information input by the user to be effective, and a button 48 for information input by the user to ineffective.

The simulation program executes the processes described above by using the azimuthal angle φ and the polar angle θ of the liquid crystal molecule 6, which are input by the user at the orientation setting dialog 40 for setting the orientation of the liquid crystal molecule 6.

When the user checks the check area 45 for inputting the dispersion range α, an input area 45a for inputting the dispersion range α is displayed at the orientation setting dialog 40 as shown in FIG. 8B. FIG. 8B is a diagram illustrating the orientation setting dialog for setting the orientation of the liquid crystal molecule 6 when the dispersion range α is checked.

In FIG. 8B, when the check area 45 is checked, since the input area 45a for inputting the dispersion range α is displayed, the user input the dispersion range a in the input area 45a.

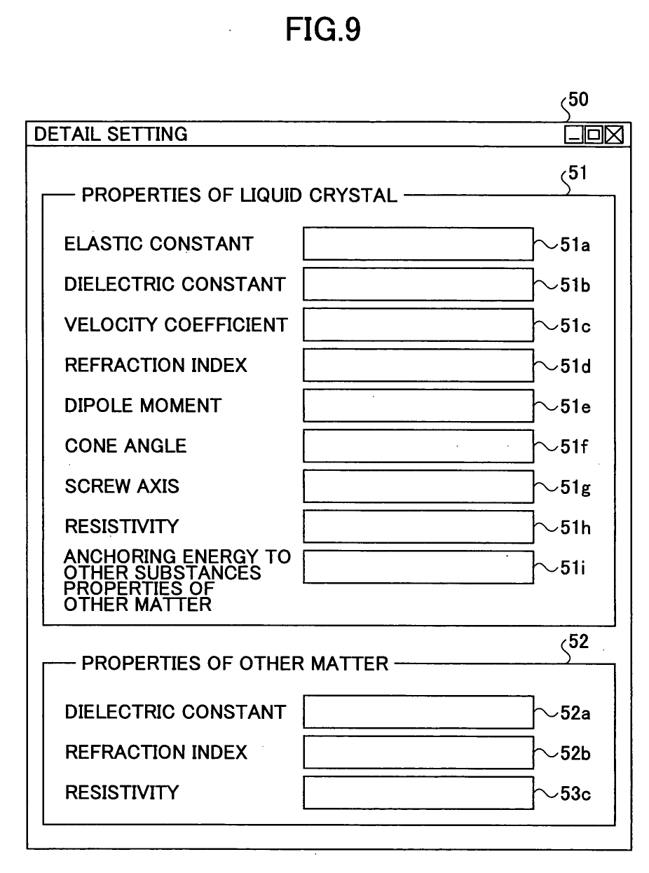

At the orientation setting dialog 40 as shown in FIG. 8A and FIG. 8B, when the user clicks the button 46 to set the detailed properties of the dispersion, a screen as shown in FIG. 9 is displayed.

FIG. 9 is a diagram illustrating a detailed setting screen.

In FIG. 9, the detailed setting screen 50 includes an area 51 for setting the dispersion range of the properties of the liquid crystal, and an area 52 for setting the dispersion range of properties of other matter.

For example, as a factor influencing an arrangement of the liquid crystal molecule 6, the area 51 for setting the dispersion range of the properties of the liquid crystal includes a setting area 51a for setting the dispersion range of an elastic constant, a setting area 51b for setting the dispersion range of a dielectric constant, a setting area 51c for setting the dispersion range of a velocity coefficient, a setting area 51d for setting the dispersion range of a refraction index, a setting area 51e for setting the dispersion range of a dipole moment, a setting area 51f for setting the dispersion range of a cone angle, a setting area 51g for setting the dispersion range of a screw axis, a setting area 51h for setting the dispersion range of the resistivity, and a setting area 51i for setting an anchoring energy to other matter.

For example, as a factor influencing an arrangement of the liquid crystal molecule 6, the area 52 for setting the properties of other matter includes a setting area 52a for setting the dispersion range of a dielectric constant, a setting area 52b for setting the dispersion range of a refraction index, and a setting area 52c for setting the dispersion range of the resistivity.

Property values set in the area 51 for setting the dispersion range of the property of the liquid crystal and the area 52 for setting the dispersion range of the properties of other matter are applied in various expressions above-described with reference to FIG. 3. Accordingly, it is possible to conduct a simulation truly reproducing an orientation phenomenon in the actual liquid crystal element 10.

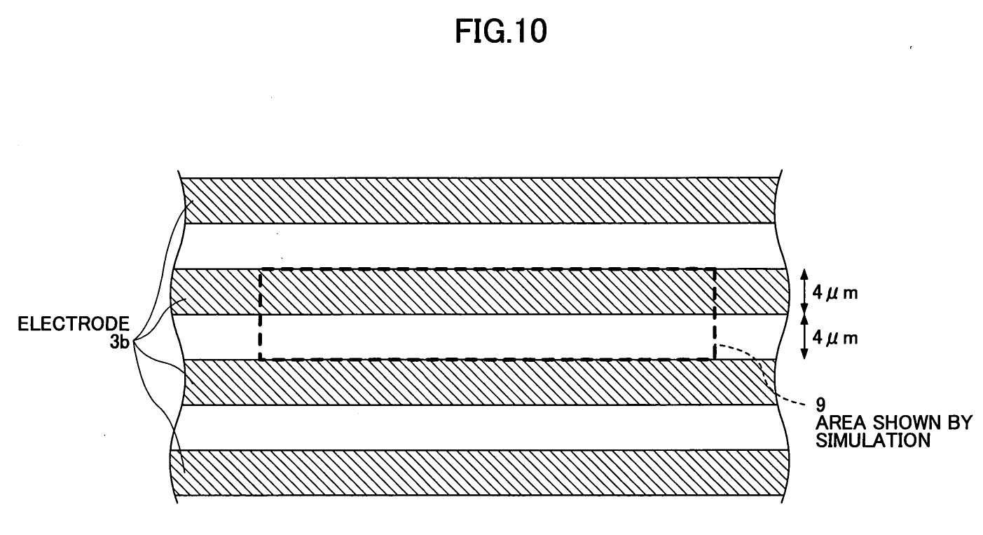

For example, as shown in FIG. 1, the electrode 3a is formed allover one of the transparent substrates 2 and the electrode 3b is formed in strip patterns having a width 4 μm and an interval 4 μm on another of the transparent substrates 2. A case, in which the orientation phenomenon of the liquid crystal molecule 6 is calculated using the simulation program according to the embodiment of the present invention in the liquid crystal element 10 having an interval 4 μm between the transparent substrates 2 as shown in FIG. 10, will be described.

First, an assumption will be described. In the assumption, the orientation direction of each of the liquid crystal molecules 6 is vertical to a transparent substrate surface on the interface 7 of the transparent substrate 2 (FIG. 4). In this case, an angle of the dispersion range a shown in FIG. 5 is set to be 0.5°. That is, on the interface 7 of the transparent substrate 2, when a voltage is not applied, the liquid crystal molecule 6 for each node point is set to randomly disperse within the angle 0.5° centering a direction vertical to the transparent substrate surface.

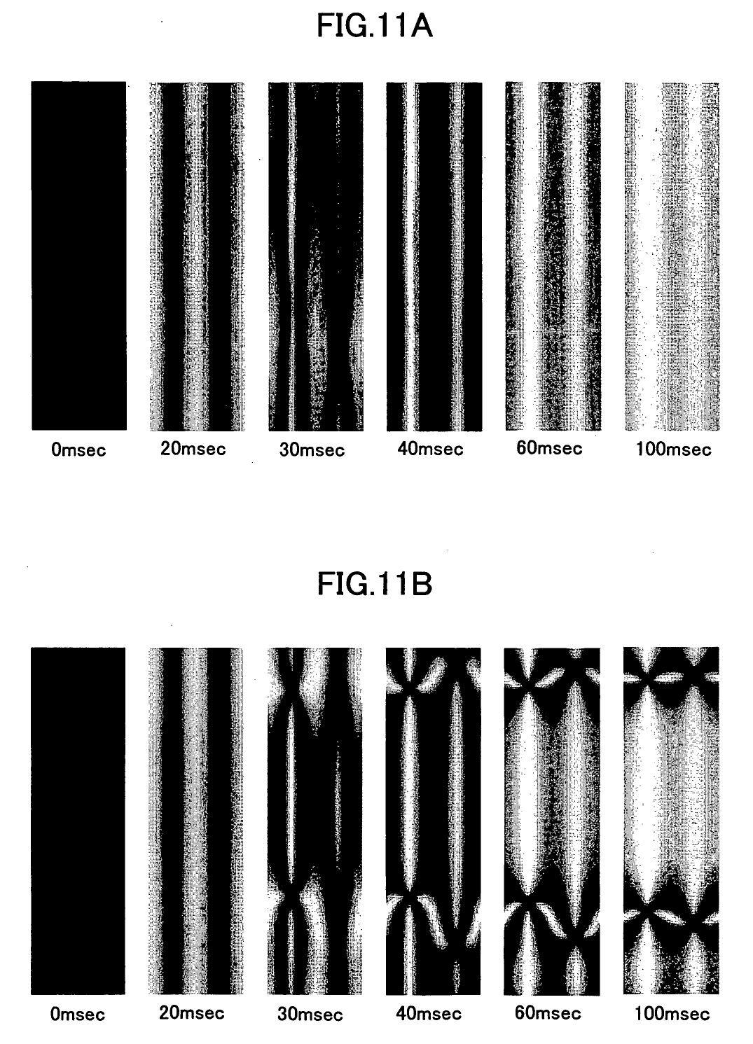

A nematic liquid crystal having a negative anisotropy of the dielectric constant is used for the liquid crystal. A voltage 0V is applied to the electrode 3a being formed allover one of the transparent substrates 2 and a voltage 5.5V is applied to the electrode 3b being formed in the strip patterns on another of the transparent substrates 2. Under this assumption, the simulation program described with reference to FIG. 3 and FIG. 7 calculates a transmittance distribution at each time interval. Results of the calculation of the simulation program are shown in FIG. 11A and FIG. 11B. FIG. 11A is a diagram showing a first calculation result at each time interval, which is conducted by the simulation program according to the embodiment of the present invention. FIG. 11B is a diagram showing a second calculation result at each time interval, which is conducted by the simulation program according to the embodiment of the present invention. In FIG. 11A and FIG. 11B, the liquid crystal element is configured in the same manner.

In FIG. 11A and FIG. 11B, an area 9 is simulated by the simulation program and displayed at the display unit 53.

In FIG. 11A and FIG. 11B, the calculation result shows the orientation phenomenon of the liquid crystal molecules 6 at predetermined intervals 20 msec from 0 msec to 100 msec.

Referring to the calculation result in FIG. 11A and FIG. 11B, since the dispersion of the orientation on the interface, even if the liquid crystal element is configured in the same manner, it can be seen that the first calculation result shown in FIG. 11A shows a different orientation phenomenon from the second calculation result shown in FIG. 11B. The simulation program shows a different result each time when it calculates the orientation direction of each of the liquid crystal molecules 6.

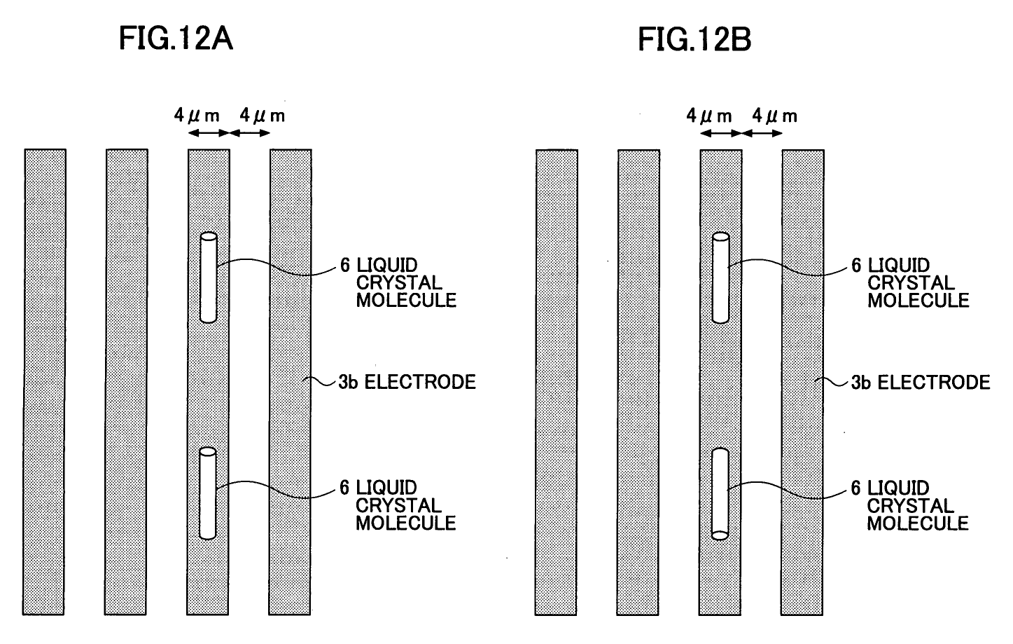

FIG. 12A and FIG. 12B are diagrams showing an orientation state of the liquid crystal molecules 6 at the same time t(k) in FIG. 11A and FIG. 11B. For example, in FIG. 12A, even if two liquid crystal molecules 6 tilt in an approximate identical direction on a strip direction, when the simulation program is executed again, the same two liquid crystal molecules 6 do not always tilt in the approximate identical direction as the same as the previous direction as shown in FIG. 12B. On the strip direction, the two liquid crystal molecules 6 may tilt in an opposite direction from each other, so that a boundary of domains occurs between regions where the two liquid crystal molecules 6 tilt in the opposite direction from each other. That is, it is possible to realistically reproduce a behavior of the actual liquid crystal element 10 by calculating the orientation on the interface considering the dispersion.

On the other hand, if the orientation on the interface is calculated and simulated by conventional simulation software which does not consider the dispersion, the calculation result can be always the same. That is, the conventional simulation software cannot realistically reproduce the behavior of the actual liquid crystal element 10.

The present invention can be applied to other configuration of the liquid crystal element 10 without any limitation regarding the configuration of the liquid crystal element 10 as described above.

Moreover, the process for generating the random number in step S33 in FIG. 7 may be conducted for more than one node point (x(i),z(j)) which is randomly selected.

As described above, according to the present invention, the simulation program (simulation software) can be realized in that the orientation phenomenon of the actual liquid crystal element 10 is realistically reproduced.

According to the present invention, the orientation for each of the liquid crystal molecules of the liquid crystal element 10 can be simulated considering the dispersion.

The present invention is not limited to the specifically disclosed embodiments, and variations and modifications may be made without departing from the scope of the invention.

The present application is based on

Japanese Priority Application No. 2004-119274 filed on Apr. 14, 2004, the entire contents of which are hereby incorporated by reference.

1. A computer-readable recording medium recorded with a simulation program for causing a computer to simulate a liquid crystal molecule arrangement in a liquid crystal element, said simulation program comprising:
setting a dispersion range of at least one factor which determines the liquid crystal molecule arrangement; and
determining an orientation direction of each of liquid crystal molecules in the liquid crystal element within the dispersion range set in said setting the dispersion range.

2. The computer-readable recording medium as claimed in claim 1, wherein said determining the orientation direction determines the orientation direction for each of the liquid crystal molecules based on an angle showing the dispersion range set in said setting dispersion range, said angle centering a predetermined orientation direction which is determined by an azimuthal angle and a polar angle of said liquid crystal molecules.

3. The computer-readable recording medium as claimed in claim 1, wherein said determining the orientation direction randomly determines the orientation direction within the dispersion range.

4. The computer-readable recording medium as claimed in claim 1, wherein said determining the orientation direction randomly determines the orientation direction within the dispersion range after a predetermined time lapses.

5. The computer-readable recording medium as claimed in claim 1, wherein said determining the orientation direction determines the orientation direction at one or more node points.

6. The computer-readable recording medium as claimed in claim 1, wherein said determining the orientation direction determines the orientation direction so as to minimize a potential energy in a region subject to be processed including a plurality of the node points.

7. The computer-readable recording medium as claimed in claim 1, wherein said setting the dispersion range sets the dispersion range for at least one of an orientation of a liquid crystal, properties of the liquid crystal, properties of matter other than the liquid crystal configuring the liquid crystal element, as the factor.

8. The computer-readable recording medium as claimed in claim 1, wherein as the factor, properties of a liquid crystal include one or more of an elastic constant, a dielectric constant, a velocity coefficient, a refraction index, a screw axis, a dipole moment, a cone angle, a resistivity, and an anchoring energy to other matter.

9. The computer-readable recording medium as claimed in claim 1, wherein as the factor, properties of matter other than a liquid crystal includes one or more of an refraction index and resistivity.

10. The computer-readable recording medium as claimed in claim 1, wherein said setting the dispersion range includes:
obtaining the orientation direction from a user; and
obtaining the dispersion range from the user.

11. A simulation program for causing a computer to simulate a liquid crystal molecule arrangement in a liquid crystal element, said simulation program comprising:
setting a dispersion range of at least one factor which determines the liquid crystal molecule arrangement; and
determining an orientation direction of each of liquid crystal molecules in the liquid crystal element within the dispersion range set in said setting the dispersion range.

12. A simulation apparatus for simulating a liquid crystal molecule arrangement in a liquid crystal element, said simulation apparatus comprising:
a setting part setting a dispersion range of at least one factor which determines the liquid crystal molecule arrangement; and
determining part determining an orientation direction of each of liquid crystal molecules in the liquid crystal element within the dispersion range set by said setting part.

13. A simulation method for simulating a liquid crystal molecule arrangement in a liquid crystal element, said simulation method comprising:
setting a dispersion range of at least one factor which determines the liquid crystal molecule arrangement; and
determining an orientation direction of each of liquid crystal molecules in the liquid crystal element within the dispersion range set by said setting the dispersion range.
